(19) United States
(12) Patent Application Publication
(10) Pub. No.: US 2012/0189042 A1
(43) Pub. Date: Jul. 26, 2012

(54) Building, Transmitting, and Receiving Robust Protocol Data Units in Power Line Communications

(75) Inventors: Badri N. Varadarajan, Mountain View, CA (US); Il Han Kim, Dallas, TX (US); Shu Du, San Jose, CA (US); Anand G. Dabak, Plano, TX (US)

(73) Assignee: TEXAS INSTRUMENTS INCORPORATED, Dallas, TX (US)

(21) Appl. No.: 13/347,366

(22) Filed: Jan. 10, 2012

Related U.S. Application Data
(60) Provisional application No. 61/431,518, filed on Jan. 11, 2011.

(51) Int. Cl. H04B 3/58; H04B 1/38

(52) U.S. Cl. 375/222; 375/257

(57) ABSTRACT

Systems and methods for building, transmitting, and receiving robust protocol data units (PDUs) in power line communications (PLC) are described. In some embodiments, a method may include receiving a PDU, applying bit-level repetition to at least a portion of the PDU to create a repeated portion, block interleaving two or more symbols corresponding to the repeated portion to create a block interleaved portion, inserting pilot tones in the block interleaved portion, and modulating each tone in the block interleaved portion with respect to a nearest one of the inserted pilot tones to create a robust PDU. In some implementations, the robust PDU may include a first header portion carrying information encoded using a first version of a PLC protocol (e.g., a legacy standard) and a second header portion carrying information encoded using a second version of the PLC protocol (e.g., a newer version of the same standard).

### CROSS-REFERENCE TO RELATED APPLICATION

This application claims the benefit of the filing date of U.S. Provisional Patent Application No. 61/431,518 titled “Proposal for PHY Issues and Discussion of Backward Compatibility” and filed Jan. 11, 2011, the disclosure of which is hereby incorporated by reference herein in its entirety.

### TECHNICAL FIELD

This specification is directed, in general, to power line communications, and, more specifically, to systems and methods of building, transmitting, and receiving robust protocol data units (PDUs) in power line communications.

### BACKGROUND

Power line communications (PLC) include systems for communicating data over the same medium (i.e., a wire or conductor) that is also used to transmit electric power to residences, buildings, and other premises. Once deployed, PLC systems may enable a wide array of applications, including, for example, automatic meter reading and load control (i.e., utility-type applications), automotive uses (e.g., charging electric cars), home automation (e.g., controlling appliances, lights, etc.), and/or computer networking (e.g., Internet access), to name only a few.

Various PLC standardizing efforts are currently being undertaken around the world, each with its own unique characteristics. Generally speaking, PLC systems may be implemented differently depending upon local regulations, characteristics of local power grids, etc. Examples of competing PLC standards include the IEEE 1901, HomePlug AV, and ITU-T G.hn (e.g., G.9960 and G.9961) specifications. Another standardization effort includes, for example, the Powerline-Related Intelligent Metering Evolution (PRIME) standard designed for OFDM-based (Orthogonal Frequency-Division Multiplexing) communications. The current or existing PRIME standard referred to herein is the Draft Standard prepared by the PRIME Alliance Technical Working Group (PRIME R1.3E) and earlier versions thereof.

### SUMMARY

Systems and methods for building, transmitting, and receiving robust protocol data units (PDUs) in power line communications (PLC) are described. In various embodiments, the systems and methods described herein may, for example, provide reliable communications in severe channel environments used by PLC networks.

In an illustrative, non-limiting embodiment, a method may include receiving a PDU, applying bit-level repetition to a portion of the PDU to create a robust PDU, and transmitting the robust PDU over a power line. In various implementations, the PLC device may be a PLC modem or the like. In some embodiments, the bit-level repetition may be performed after a convolution encoding operation and/or prior to an interleaving operation. Moreover, applying the bit-level repetition may include repeating each bit of the portion of the PDU two or four times. In some cases, the portion of the PDU may include a header and excludes a payload. In other cases, the portion of the PDU may include a header and a payload.

The method may also include block-interleaving symbols corresponding to the portion of the PDU after the bit-level repetition to create the robust PDU. For instance, block interleaving may include 4-symbol interleaving. The method may further include inserting pilot tones in tone data corresponding to the portion of the PDU after the block interleaving to create the robust PDU. For example, the pilot tones may be inserted every 6th tone in the data. The method may then include modulating the each tone in the tone data with respect to a nearest pilot tone to create the robust PDU. In some cases, the robust PDU may include a first header portion carrying information using a legacy version of a PLC protocol and a second header portion carrying information using a current version of the PLC protocol.

In another illustrative, non-limiting embodiment, a method may include receiving a PDU, applying bit-level repetition to at least a portion of the PDU to create a repeated portion, block interleaving two or more symbols corresponding to the repeated portion to create a block interleaved portion, inserting pilot tones in the block interleaved portion, modulating each tone in the block interleaved portion with respect to a nearest one of the inserted pilot tones to create a robust PDU, and transmitting the robust PDU over a power line. In some embodiments, the bit-level repetition repeats each bit of the at least one portion of the PDU four times, the block interleaving may interleave sets of four symbols of the repeated portion, and the pilot tones may be inserted as every 6th tone in the block interleaved portion. Also, the robust PDU may include a first header portion carrying information encoded using a first version of a PLC protocol and a second header portion carrying information encoded using a second version of the PLC protocol.

In yet another illustrative, non-limiting embodiment, a method may include receiving a PDU over a power line and decoding a first header portion of the PDU, the first header portion carrying information using a first version of a PLC protocol. The method may also include determining, based at least in part upon the information, that a subsequent portion of the PDU includes other information encoded using a second version of the PLC protocol, as well as a length of the subsequent portion. The method may then include waiting an amount of time corresponding to the length of the subsequent portion prior to attempting to communicate over the power line. In various implementations, at least a portion of the received PDU may have been encoded using at least one of: bit-level repetition, multi-symbol interleaving, or nearest-pilot tone modulation.

In some implementations, one or more of the techniques described herein may be performed by one or more computer systems. In other implementations, a tangible computer-readable storage medium may have program instructions stored thereon that, upon execution by one or more computer systems, cause the one or more computer systems to execute one or more operations disclosed herein. In yet other implementations, a system (e.g., a PLC modem) may include at least one processor and a memory coupled to the at least one processor. Examples of a processor include, but are not limited to, a digital signal processor (DSP), an application specific integrated circuit (ASIC), a system-on-chip (SoC) circuit, a field-programmable gate array (FPGA), a microprocessor, or a microcontroller. The memory may be configured to store program instructions executable by the at least one processor to cause the system to execute one or more operations disclosed herein.

### BRIEF DESCRIPTION OF THE DRAWINGS

Having thus described the invention(s) in general terms, reference will now be made to the accompanying drawings, wherein:

FIG. 1 is a block diagram of a power line communication (PLC) environment according to some embodiments.

FIG. 2 is a block diagram of a PLC device or modem according to some embodiments.

FIG. 3 is a block diagram of an integrated circuit according to some embodiments.

FIGS. 4-6 are block diagrams illustrating connections between a PLC transmitter and/or receiver circuitry to three-phase power lines according to some embodiments.

FIG. 7 is a diagram of a robust protocol data unit (PDU) according to some embodiments.

FIG. 8 is a block diagram of components of the transmitter using a 4-bit repetition code at the output of the convolutional encoder according to some embodiments.

FIG. 9 is a block diagram of additional components of the transmitter using 4-symbol block interleaving according to some embodiments.

FIG. 10A is a diagram of prior art symbol modulation scheme.

FIG. 10B is a diagram illustrating a nearest-pilot tone modulation scheme according to some embodiments.

FIG. 11 is a graph showing frame error rate (FER) performance over an additive white Gaussian noise (AWGN) channel for different robust modes of operation according to some embodiments.

FIG. 12 is a diagram illustrating a backwards compatible, robust PDU according to some embodiments.

FIG. 13 is a flowchart of a method of backward compatible detection according to some embodiments.

FIG. 14 is a block diagram of a computing system configured to implement certain systems and methods described herein according to some embodiments.

### DETAILED DESCRIPTION

The invention(s) now will be described more fully hereinafter with reference to the accompanying drawings. The invention(s) may, however, be embodied in many different forms and should not be construed as limited to the embodiments set forth herein. Rather, these embodiments are provided so that this disclosure will be thorough and complete, and will fully convey the scope of the invention(s) to a person of ordinary skill in the art. A person of ordinary skill in the art may be able to use the various embodiments of the invention(s).

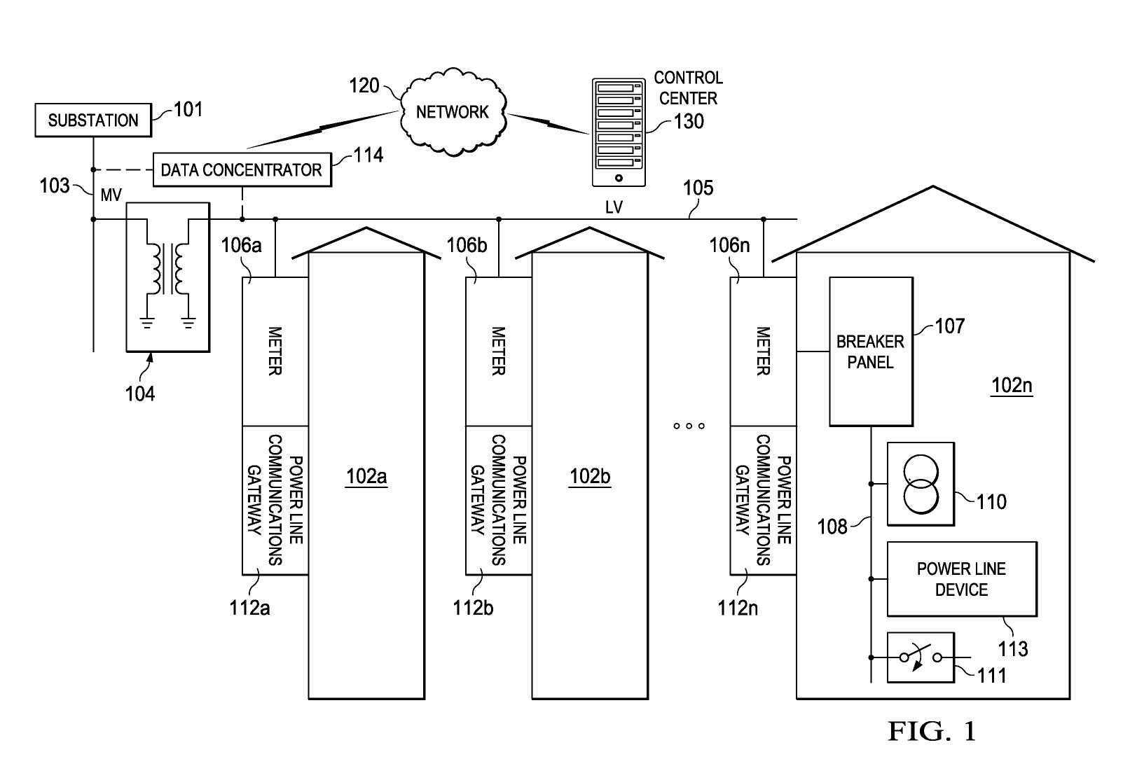

Turning to FIG. 1, an electric power distribution system is depicted according to some embodiments. Medium voltage (MV) power lines 103 from substation 101 typically carry voltage in the tens of kilovolts range. Transformer 104 steps the MV power down to low voltage (LV) power on LV lines 105, carrying voltage in the range of 100-240 VAC. Transformer 104 is typically designed to operate at very low frequencies in the range of 50-60 Hz. Transformer 104 does not typically allow high frequencies, such as signals greater than 100 KHz, to pass between LV lines 105 and MV lines 103. LV lines 105 feed power to customers via meters 106a-n, which are typically mounted on the outside of residences 102a-n. (Although referred to as “residences,” premises 102a-n may include any type of building, facility or location where electric power is received and/or consumed.) A breaker panel, such as panel 107, provides an interface between meter 106n and electrical wires 108 within residence 102n. Electrical wires 108 deliver power to outlets 110, switches 111 and other electric devices within residence 102n.

The power line topology illustrated in FIG. 1 may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use, for example, a carrier signal having a frequency different from that of the power signal. The carrier signal may be modulated by the data, for example, using an orthogonal frequency division multiplexing (OFDM) scheme or the like.

PLC modems or gateways 112a-n at residences 102a-n use the MV/LV power grid to carry data signals to and from PLC data concentrator 114 without requiring additional wiring. Concentrator 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, power line communication networks may provide street lighting control and remote power meter data collection.

One or more data concentrators 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

In some embodiments, each concentrator 114 may be seen as a based node for a PLC domain, each such domain comprising downstream PLC devices that communicate with control center 130 through a respective concentrator 114. For example, in FIG. 1, device 106a-n, 112a-n, and 113 may all be considered part of the PLC domain that has data concentrator 114 as its base node; although in other scenarios other devices may be used as the base node of a PLC domain. In a typical situation, multiple nodes may be deployed in a given PLC network, and at least a subset of those nodes may be tied to a common clock through a backbone (e.g., Ethernet, digital subscriber loop (DSL), etc.).

Still referring to FIG. 1, meter 106, gateways 112, PLC device 113, and data concentrator 114 may each be coupled to or otherwise include a PLC modem or the like. The PLC modem may include transmitter and/or receiver circuitry to facilitate the device's connection to power lines 103, 105, and/or 108.

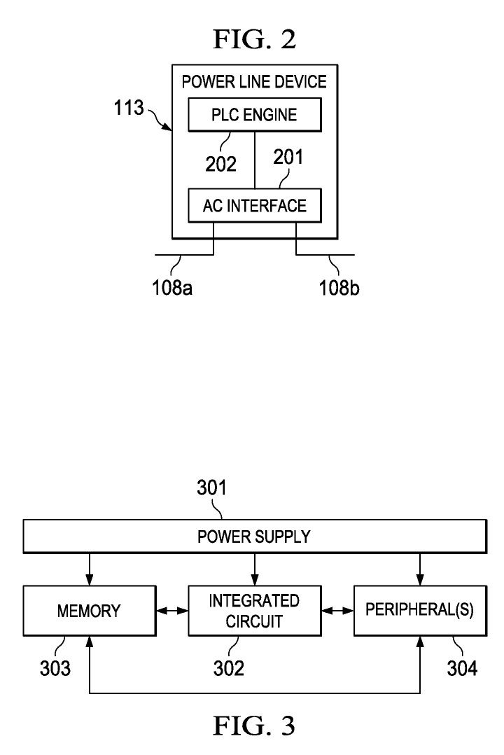

FIG. 2 is a block diagram of PLC device or modem 113 according to some embodiments. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. As noted above, in some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data aggregators 114, etc.) for further processing. Conversely, PLC engine 202 may receive instructions and/or other information from such higher-level PLC devices encoded in PLC signals, for example, to allow PLC engine 202 to select a particular frequency band in which to operate.

In various embodiments, PLC device 113 may be implemented at least in part as an integrated circuit. FIG. 3 is a block diagram of such an integrated circuit. In some cases, one or more of meter 106, gateway 112, PLC device 113, or data concentrator 114 may be implemented similarly as shown in FIG. 3. For example, integrated circuit 302 may be a digital signal processor (DSP), an application specific integrated circuit (ASIC), a system-on-chip (SoC) circuit, a field-programmable gate array (FPGA), a microprocessor, a microcontroller, or the like. As such, integrated circuit 302 may implement, at least in part, at least a portion of PLC engine 202 shown in FIG. 2. Integrated circuit 302 is coupled to one or more peripherals 304 and external memory 303. Further, integrated circuit 302 may include a driver for communicating signals to external memory 303 and another driver for communicating signals to peripherals 304. Power supply 301 is also provided which supplies the supply voltages to integrated circuit 302 as well as one or more supply voltages to memory 303 and/or peripherals 304. In some embodiments, more than one instance of integrated circuit 302 may be included (and more than one external memory 303 may be included as well).

Peripherals 304 may include any desired circuitry, depending on the type of PLC device or system. For example, in some embodiments, peripherals 304 may implement, at least in part, at least a portion of a PLC modem (e.g., portions of AC interface 210 shown in FIG. 2). Peripherals 304 may also include additional storage, including RAM storage, solid-state storage, or disk storage. In some cases, peripherals 304 may include user interface devices such as a display screen, including touch display screens or multi-touch display screens, keyboard or other input devices, microphones, speakers, etc.

External memory 303 may include any type of memory. For example, external memory 303 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, etc. External memory 303 may include one or more memory modules to which the memory devices are mounted, such as single inline memory modules (SIMMs), dual inline memory modules (DIMMs), etc.

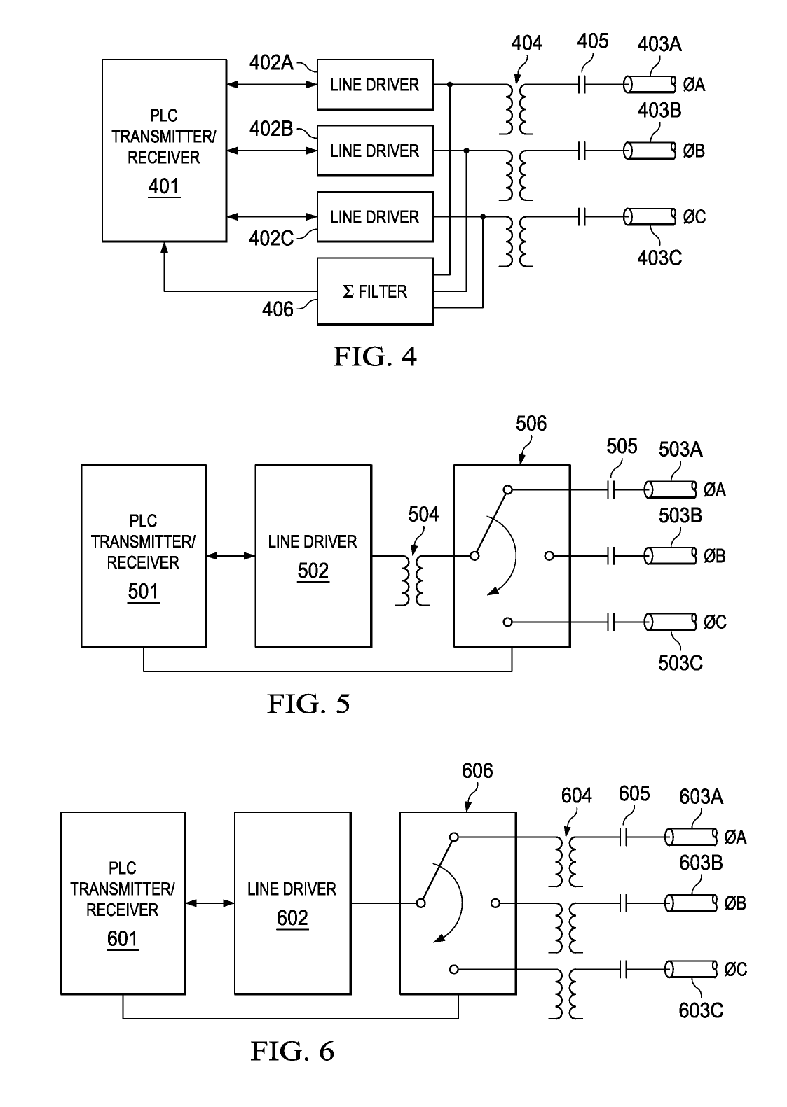

In various implementations, PLC device or modem 113 may include transmitter and/or receiver circuits configured to connect to power lines 103, 105, and/or 108. FIG. 4 illustrates the connection between the power line communication transmitter and/or receiver circuitry to the power lines according to some embodiments. PLC transmitter/receiver 401 may function as the transmitter and/or receiver circuit. PLC transmitter/receiver 401 generates pre-coded signals for transmission over the power line network. Each output signal, which may be a digital signal, is provided to a separate line driver circuit 402A-C. Line drivers 402A-C comprise, for example, digital-to-analog conversion circuitry, filters, and/or line drivers that couple signals from PLC transmitter/receiver 401 to power lines 403A-C. Transformer 404 and coupling capacitor 405 link each analog circuit/line driver 402 to its respective power line 403A-C. Accordingly, in the embodiment illustrated in FIG. 4, each output signal is independently linked to a separate, dedicated power line.

FIG. 4 further illustrates an alternate receiver embodiment. Signals are received on power lines 403A-C, respectively. In an embodiment, each of these signals may be individually received through coupling capacitors 405, transformers 404, and line drivers 402 to PLC transmitter/receiver 401 for detection and receiver processing of each signal separately. Alternatively, the received signals may be routed to summing filter 406, which combines all of the received signals into one signal that is routed to PLC transmitter/receiver 401 for receiver processing.

FIG. 5 illustrates an alternative embodiment in which PLC transmitter/receiver 501 is coupled to a single line driver 502, which is in turn coupled to power lines 503A-C by a single transformer 504. All of the output signals are sent through line driver 502 and transformer 504. Switch 506 selects which power line 503A-C receives a particular output signal. Switch 506 may be controlled by PLC transmitter/receiver 501. Alternatively, switch 506 may determine which power line 503A-C should receive a particular signal based upon information, such as a header or other data, in the output signal. Switch 506 links line driver 502 and transformer 504 to the selected power line 503A-C and associated coupling capacitor 505. Switch 506 also may control how received signals are routed to PLC transmitter/receiver 501.

FIG. 6 is similar to FIG. 5 in which PLC transmitter/receiver 1901 is coupled to a single line driver 1902. However, in the embodiment of FIG. 6, power lines 603A-C are each coupled to a separate transformer 604 and coupling capacitor 605. Line driver 602 is coupled to the transformers 604 for each power line 603 via switch 606. Switch 606 selects which transformer 604, coupling capacitor 605, and power line 603A-C receives a particular signal. Switch 606 may be controlled by PLC transmitter/receiver 601, or switch 606 may determine which power line 603A-C should receive a particular signal based upon information, such as a header or other data, in each signal. Switch 606 also may control how received signals are routed to PLC transmitter/receiver 601.

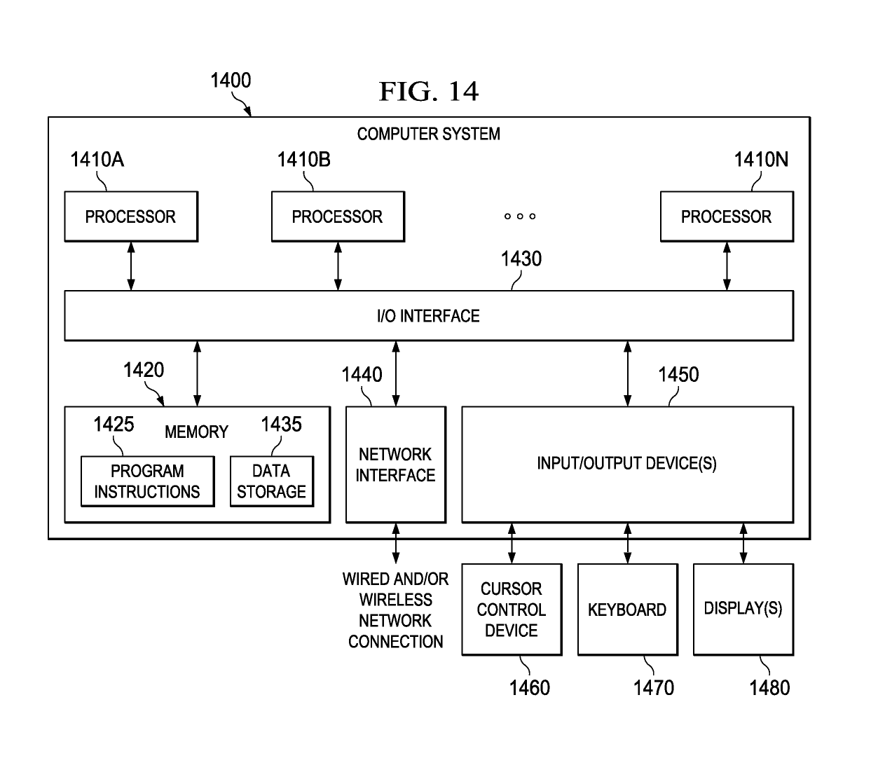

In some embodiments, the circuits described above (and/or the computer system shown in FIG. 14) may implement signal processing operations configured to generate, transmit, and/or receive one or more PLC signals communicated over one or more power lines. Generally speaking, these PLC signals may be transmitted in the form of data frames or Protocol Data Units (PDUs), each such PDU including a preamble, a header, and a payload. For any given PLC standard, certain systems and methods described herein may provide one or more “robust” modes of operation that may enable, among other things, more reliable communications in severe channel environments. As described in more detail below, implementing a given robust mode of operation may include adding bit-level repetition, multiple-symbol interleaving, and/or nearest-pilot tone modulation to the processing prescribed by a given PLC standard. Also, in various embodiments, different robust modes of operation may include modifications to the PDU's header, payload, or both.

In some cases, a robust mode may be seen as a subsequent version of an existing standard. For instance, in a particular situation where one or more techniques described herein are applied to the PRIME 1.3E standard, the PRIME 1.3E standard may thereafter be considered a “legacy standard,” and PLC devices operating under that protocol to transmit and receive “legacy PDUs” may be designated as “legacy devices.” In contrast, the robust version of the PRIME 1.3E standard may be part of a subsequent version of that standard (e.g., “PRIME 1.4”), and devices capable of operating using the new protocol to transmit and receive “robust PDUs” may be referred to as “robust devices.” As described below, robust PDUs and/or headers may be modified to enable device-level and network-level compatibility among devices and nodes supporting legacy and robust protocols.

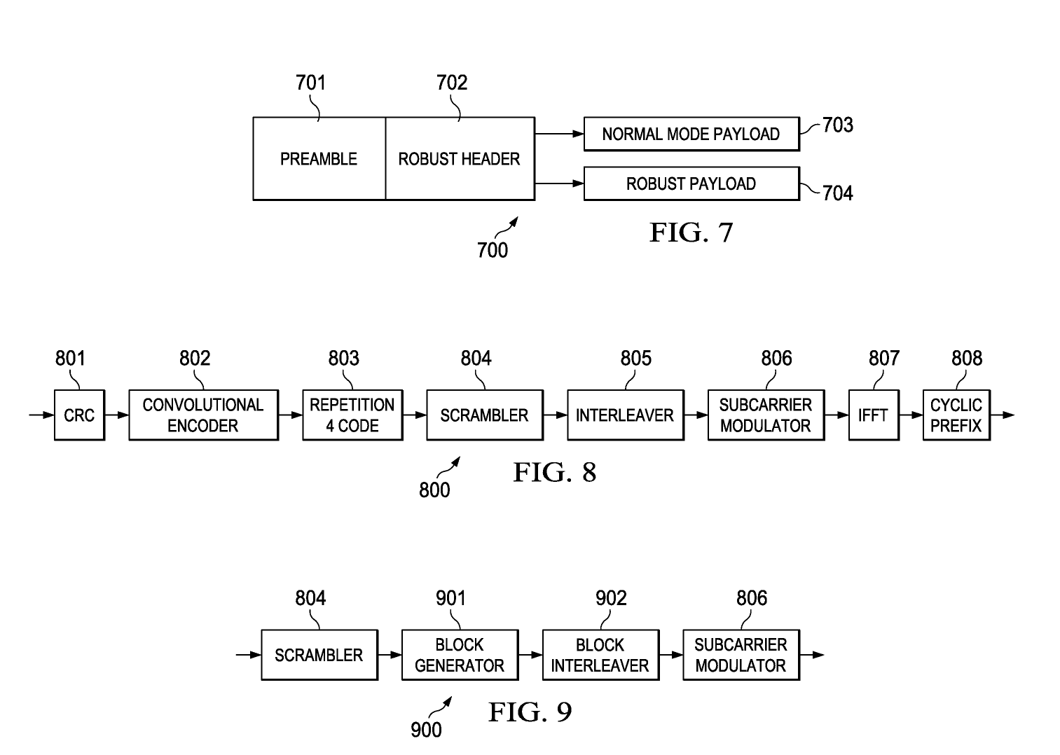

Turning now to FIG. 7, a diagram of a robust PLC packet or PDU is depicted according to some embodiments. Particularly, robust PDU 700 includes preamble portion 701, header portion 702, and one of payload portions 703 or 704, depending upon whether the communication is utilizing a normal payload mode or a robust payload mode, respectively. In some cases, use of normal or robust payload modes may be indicated in header portion 702, which may itself be robust. Therefore, with respect to the types of payload that may be used, a first robust protocol may use a robust header portion (e.g., 702) and a “normal” payload portion (e.g., 703), and a second robust mode may use both a robust header portion (e.g., 702) and a robust payload portion (e.g., 704). (A comparison between legacy, normal, and robust payload portions is discussed in more detail below with respect to Table II.)

Generally speaking, each of portions 701-704 may contain different symbols (e.g., OFDM symbols) and may have distinct formats depending upon the PLC standard being used in a given communication. For instance, the G3 and G.9955 standards are largely similar. Nonetheless, there are differences between them in terms of sampling frequency, tone spacing, coherent/differential modulation, etc. In some cases, the various embodiments described below, systems and methods for generating, transmitting, and/or receiving PLC frames may be used with any such PLC standard (e.g., PRIME, G3 CENELEC A, G3 FCC, G.hnem, IEEE 1901.2 devices, SFSK, etc.).

In certain embodiments implementing the PRIME standard, preamble portion 701 of robust PDU 700 may include a chirp preamble 2.048 ms long, similar to PRIME 1.3E. However, header portion 703 of robust PDU 700 may differ from the header of a legacy, PRIME 1.3E PDU, as described in Table I below:

TABLE I

| PRIME 1.3E HEADER | Robust Header |
|---|---|
| 13 pilot tones, 84 data subcarriers | 17 pilot tones, 80 data subcarriers |
| Differential Binary Phase Shift | DBPSK, FEC on, 4-bit repetitions |
| Keying (DBPSK), Forward Error | |
| Correction (FEC) on | |
| Frequencies are differential with | Frequencies are differential with |
| respect to previous subcarrier | respect to nearest pilot tone |
| One-symbol interleaver | Four-symbol interleaver |
| 2 symbols of 2.24 ms each | 4 symbols of 2.24 ms each |

Also, normal mode payload 703 and robust mode payload 704 may each differ from the payload of a legacy PRIME 1.3E payload, as shown in Table II below:

TABLE II

| PRIME 1.3E Payload | Normal Mode Payload | Robust Mode Payload |
|---|---|---|
| 0-63 symbols of 2.24 | 0-61 symbols of 2.24 | 0-61 symbols of 2.24 |
| ms each | ms each | ms each |
| 1 pilot, 96 data | 1 pilot, 96 data | 17 pilots, 80 data |
| subcarriers | subcarriers | subcarriers |
| DBPSK, Differential | DQPSK, D8PSK, | DBPSK, FEC on, |
| Quaternary Phase- | FEC off | 4-bit repetitions |
| Shift Keying (DQPSK), | | |
| Eight-ary Differential | | |
| Phase-Shift Keying | | |
| (D8PSK), FEC on/off | | |
| Frequencies are | Frequencies are | Frequencies are |
| differential with | differential with | differential with |
| respect to previous | respect to previous | respect to nearest |
| subcarrier | subcarrier | pilot tone |
| One-symbol | Four-symbol | Four-symbol |
| interleaver | interleaver | interleaver |

To illustrate a method of building a robust PDU as discussed above, reference is first made to FIG. 8, where a block diagram of components of a transmitter using a 4-bit repetition code at the output of the convolutional encoder is depicted according to some embodiments. As shown, the Physical (PHY) layer receives PDU inputs from the Media Access Control (MAC) layer. The PDU passes through cyclic redundancy check (CRC) block 801 and then is convolutionally encoded in convolutional encoder 802. Block 803 applies a 4-bit repetition to the output of encoder 802. For example, when the output of encoder 802 is the bit stream or sequence: {b₀, b₁, b₂, . . . }, the output of block 803 is {b₀, b₀, b₀, b₀, b₁, b₁, b₁, b₁, b₂, b₂, b₂, b₂, . . . }. In some implementations, 4-bit repetition for payload bits may be enabled when using Binary Phase Shift Keying (BPSK) modulation and convolutional coding.

The output of block 803 is scrambled in scrambler 804. The output of scrambler 804 is interleaved in interleaver 805 and then differentially modulated in subcarrier modulator 806. In some cases, scrambler 804 may be absent and the output of block 803 may be processed by interleaver 805. As shown in Tables I-II above, different portions of the PDU may be modulated using a Differential Binary Phase Shift Keying (DBPSK), Differential Quaternary Phase Shift Keying (DQPSK), or Differential Eight-Phase Shift Keying (DBPSK) schemes. Then, OFDM is performed in Inverse Fast Fourier Transform (IFFT) block 807 and cyclic prefix generator 808.

On the receiver, side blocks 801-808 may be used in the reverse order to decode/demodulated received PDUs. It should be noted that, in alternative embodiments, the order of blocks 801-808 shown in FIG. 8 may be modified (e.g., 4-bit repeater 803 may be located between blocks 850 and 806). Also, 2-bit repetition may be selected as an alternative to 4-bit repetition (yielding additional robust modes of operation).

FIG. 9 is a block diagram of additional components of a transmitter using 4-symbol block interleaving according to some embodiments. As shown, the output of scrambler 804 may be received by block generator 901 and processed by block interleaver 902 before reaching subcarrier modulator 806. In other words, compared with FIG. 8, here generator 901 and interleaver 902 replace interleaver 805. Similarly as before, when scrambler 804 is absent from the transmitter, the output of encoder 802 or of 4-bit repeater 803 may be coupled to block generator 901 instead.

For example, when the output of scrambler 804 (or encoder 802/4-bit repeater 803) is an array of OFDM symbols (e.g., B₀, B₁, B₂, . . . ), block generator 901 may group these symbols into blocks having L bits per symbol (e.g., Block 1: [B₀, B₁, . . . , B_{4L-1}], Block 2: [B_{4L}, B_{4L+1}, . . . , B_{8L-1}], . . . Block m: [B_{(m-1)L}, . . . , B_{mL-1}]), where L is an integer. In other words, the input to block generator 901 may be partitioned into blocks of 4 L bits. In some cases, if the last block (e.g., Block m) does not contain enough bits, the symbols may be cyclically repeated until 4 L bits are obtained (e.g., if the last block contains b₁, b₂, . . . , b₈ and 4 L=12, then Block m may use b₁, b₂, . . . , b₈, b₁, b₂, . . . b₈). Moreover, block interleaver 902 may perform interleaving over four consecutive OFDM symbols. (This is in contrast with PRIME 1.3E, which performs one-symbol interleaving.) Also, in some embodiments, block interleaving may be performed when FEC is turned on.

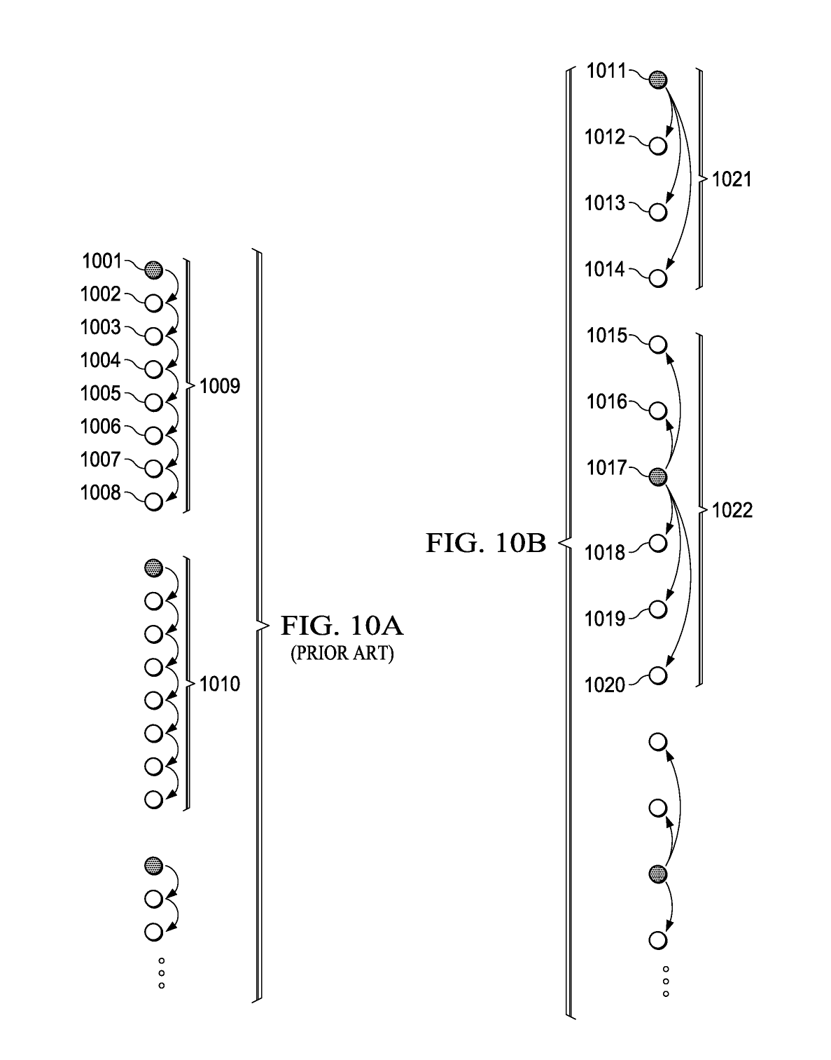

FIG. 10A is a diagram of prior art symbol modulation. In particular, pilot tone or subcarrier 1001 is shown, whereas tones or subcarriers 1002-1008 carry data. The arrows in this diagram indicate that subcarrier 1001 provides a phase reference for subcarrier 1002 (differential frequency modulation), subcarrier 1002 provides a phase reference for subcarrier 1003, etc. Subcarrier group 1009 includes only one pilot tone 1001; thus, every 8^{th} tone is a pilot tone. As such, subcarrier group 1010 has its own pilot tone. Further, a header using this type of modulation (e.g., following the PRIME 1.3E specification) would have 13 pilot tones. In contrast, FIG. 10B is a diagram illustrating a robust, nearest-pilot tone modulation scheme according to some embodiments. As shown, pilot tones (e.g., 1011 and 1017) are included every 6^{th} tone, creating subcarrier groups 1021 and 1022. Therefore, robust header 702 (of FIG. 7) may have 17 pilot tones. Moreover, robust modulation may be performed with respect to the nearest pilot tone (“nearest-pilot tone modulation”). In other words, tones 1012-1014 may use the phase reference provided by pilot tone 1011, whereas tones 1015, 1016, and 1018-1020 may use the phase reference provided by pilot tone 1017, and so on.

In some implementations, by having each tone modulated with respect to its nearest pilot tone, PLC receivers may use differential and/or coherent demodulation schemes. For example, a basic mode receiver may perform a differential demodulation with a given phase reference. On the other hand, an advanced mode receiver may perform coherent demodulation by generating a channel estimate on each pilot tone (e.g., averaging with other available pilots). More specifically, assume that the transmitted symbol Xₖ (where k in an integer) may be given by: Xₖ=X_{k-Δ}Uₖ, where Δ is chosen for every tone so that k−Δ is the nearest pilot tone, |Δ|≦3, and where Uₖ is an information symbol. Therefore, the received symbol (Yₖ) may be expressed as: Yₖ=HₖXₖ+Nₖ, where Hₖ is the channel fading and Nₖ is noise. In this scenario, a differential decoding scheme may yield a detected symbol (Zₖ) given by:

$$\begin{matrix}{Z}_{k} = angle ( {Y}_{k} {Y}_{k - 1}^{*} ) \\ = angle ( {H}_{k} {H}_{k - 1}^{*} {X}_{k} {X}_{k - 1}^{*} ) , approximating {N}_{k} = 0 \\ = angle ( {H}_{k} {H}_{k - 1}^{*} {U}_{k} ) , \\ \sim angle ( {\vert {H}_{k} \vert}^{2} {U}_{k} ) , since {H}_{k} and {H}_{k - Δ} are roughly the same phase .\end{matrix}$$

It should be noted that the performance of such differential decoding scheme may vary to the extent that Hₖ and Hₖ₋₁ may have some phase variation for Δ>1. However, using a coherent decoding scheme, a receiver may know {Xₖ} on all pilot tones. Thus, the receiver may estimate the channel Hₖ for all tones k, for example, by frequency interpolation, and it may compute Wₖ=angle(YₖĤₖ*X_{k-Δ}*) because X_{k-Δ} is a known pilot symbol. As such, the receiver may be able to estimate the channel fading from the pilot symbols, and the phase reference for all transmitted symbols is known.

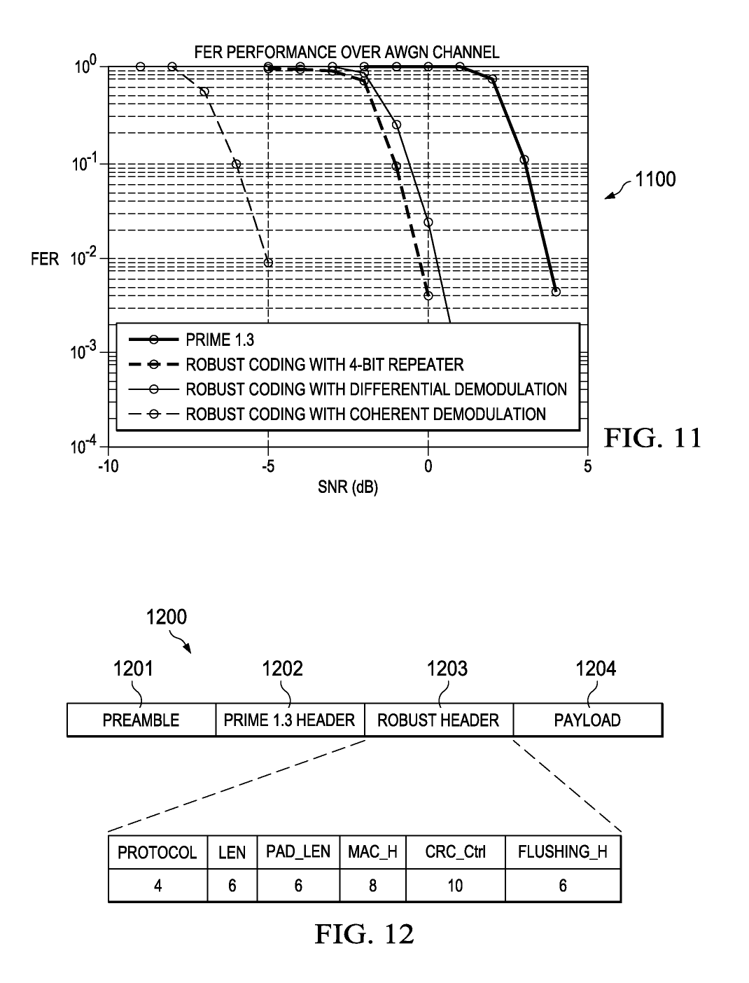

As previously noted, implementing a given robust mode of operation may include adding bit-level repetition (e.g., 4-bit or 2-bit), multi-symbol or block interleaving, and/or nearest-pilot tone modulation to a given PLC standard. Accordingly, different robust modes may be used corresponding to the different possible combinations of these various techniques. To illustrate different results obtained using these techniques, the chart of FIG. 11 shows frame error rate (FER) performance over an additive white Gaussian noise (AWGN) channel according to some embodiments. Particularly, it may be noted that transmissions using the PRIME 1.3E standard needs 4 dB improvement in signal-to-noise ratio (SNR) to achieve 1% FER. By adding 4-bit repetition, as described above with respect to FIG. 8, systems and methods described herein may provide approximately a 4.5 dB gain or improvement in SNR (“Robust coding with O-bit repeater”). Using both 4-bit repetition and block interleaving with differential demodulation (“Robust coding with differential demodulation”), as described above in connection with FIGS. 8 and 9, yields a performance similar to that of adding a 4-bit repeater to the PRIME 1.3E standard (“Robust coding with 4-bit repeater”). Furthermore, using 4-bit repetition and block interleaving with coherent demodulation (“Robust coding with coherent demodulation”), as facilitated by the use of additional pilot tones and phase referencing the closes pilot tones described above in connection with FIGS. 8, 9, and 10B, adds approximately another 5 dB performance gain in SNR (with ideal channel estimation).

In various embodiments, systems and methods described herein may enable backward compatibility between legacy and robust devices. In other words, certain techniques may be employed in the detection, by a single PLC device, of PDUs communicated using two or more different versions of a same standard (or two different standards). Accordingly, systems and methods described herein may allow a PLC device or modem to support two or more modes of operation (e.g., normal and robust) of a same standard coexisting on the PLC domain or environment in an interoperable manner.

FIG. 12 is a diagram illustrating a backwards compatible PDU and header(s) according to some embodiments. Particularly, PDU 1200 may include preamble portion 1201, first header portion 1202, second header portion 1203, and payload 1204. In some cases, payload 1204 may be a normal mode payload or a robust mode payload, as shown in FIG. 7. First header 1202 may encode information compatible with a first version of a particular PLC standard (e.g., PRIME 1.3E), and second header 1203 may include information compatible with a second version of the same standard (e.g., PRIME 1.4, etc.). Further, the encoding used second header 1203 may implement a robust version of that standard (e.g., with one or more of 4-bit repetition, block interleaving, robust modulation, etc.).

Still referring to FIG. 12, in some embodiments, second header 1203 may include a protocol field (e.g., 4 bits) indicating a modulation and coding scheme. For example, a given value may indicate a particular mode of operation. A length field (LEN) (e.g., 6 bits) may indicate a number of OFDM symbols, and it may be followed by a padding field (PAD_LEN) (e.g., 6 bits). A MAC header field (MAC_H) (e.g., 8 bits) may be allocated to suitable MAC fields (e.g., flags, HDR.0, HDR.LEVEL, etc.). For example, in some cases a PLC node may use HDR.D0 and HDR.LEVEL to check if it needs to decode a given packet. If not, the node may “go to sleep” until the end of the packet to save power. These fields may also be repeated in the MAC header (duplicated) to facilitate coding.

Second header 1203 may also include a CRC control field (CRC_ctrl) (e.g., 10 bits) to provide accurate error detection (in contrast with PRIME 1.3E, where the CRC field is shorter). A flushing header field (FLUSHING_H) (e.g., 6 bits) may include a suitable number of zeros to properly terminate a convolution encoding.

Thus, in the example discussed above, second header 1203 may have a total of 40 bits and may be encoded to yield 80 bits (i.e., it may include two symbols), which may then be repeated four times to yield 320 bits (i.e., after 4-bit repetition). This particular header length fits exactly four OFDM symbols with 80 data carriers each. (Notably, this is in contrast with PRIME 1.3E, which has 84 bits in the header, with 30 bits of PHY information and 54 bits embedded from the MAC layer.)

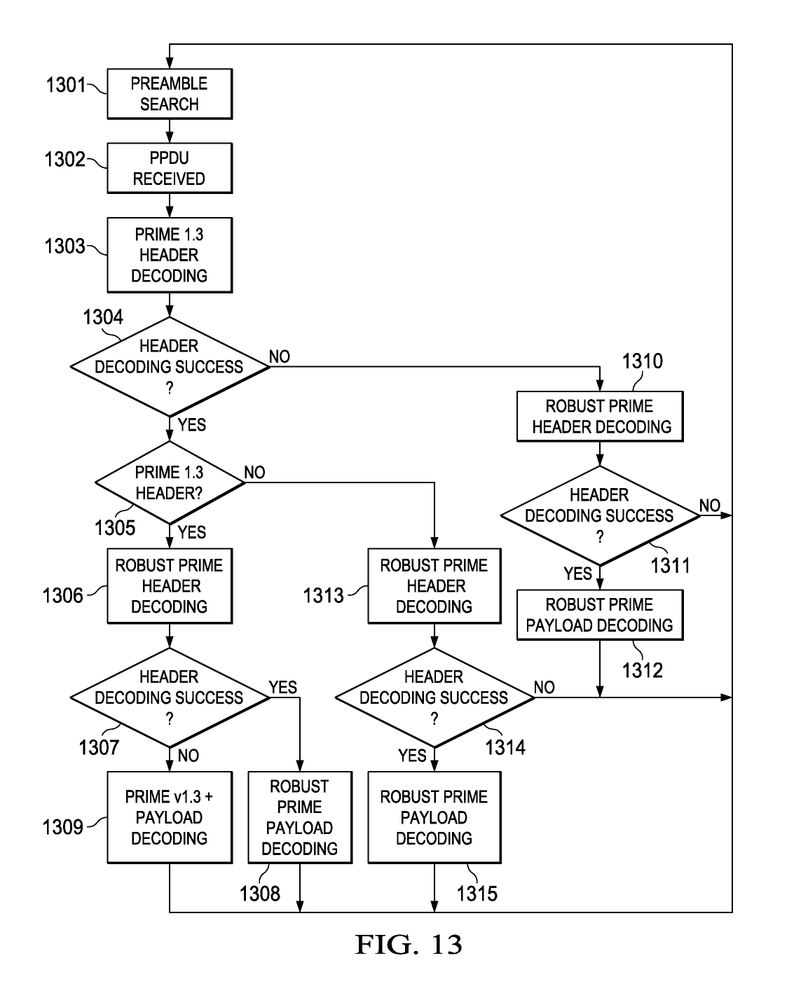

In some cases, a PLC device may decode headers for both standards by hypothesis testing and, based on the decoded header, the device may then decode the payload. FIG. 13 illustrates a method used by a robust PRIME receiver to decode a received PDU according to some embodiments. The robust PRIME receiver searches for a PDU preamble at block 1301 to identify a received PDU at block 1302. The robust PRIME receiver may receive PDUs that uses a PRIME R1.3E format or a robust PRIME format of FIG. 7. In either case, at block 1303, the robust PRIME receiver attempts to decode the PRIME R1.3E header from the PDU and evaluates whether the header was successfully decoded at block 1304.

Assuming that the PDU is in the PRIME R1.3E format, and that the decoding at block 1303 was successful, the process moves to block 1305 to confirm the PRIME R1.3E header. As such, the robust PRIME receiver recognizes that the current PDU is a PRIME R1.3E PDU. Because the robust PRIME receiver could erroneously decode the PRIME R1.3E header and still pass the CRC, the robust PRIME receiver performs a second robust header decoding at block 1306 and evaluates whether the decoding was a success at block 1307. If the header passes the CRC at blocks 1306 and 1307, then the PDU is a robust PRIME packet and the process moves to block 1308 to do robust PRIME decoding. If the header fails the CRC at blocks 1306 and 1307, then PRIME R1.3E decoding is performed at block 1309. After the correct header decoding, the robust PRIME receiver may decode the payload information.

In case that the robust PRIME receiver cannot decode the PRIME R1.3E header correctly at block 1304, the robust PRIME receiver tries to decode the robust PRIME header area of the PDU at block 1310 even though decoding may be performed on the payload portion of the received PRIME R1.3E PDU. If the CRC passes in the robust PRIME header at block 1311, then the robust PRIME payload is decoded at block 1312. If the CRC fails in the robust PRIME header at block 1311, then the process returns to block 1301 to search for the next PDU.

In case the robust PRIME receiver cannot decode the PRIME R1.3E header correctly at block 1305. The robust PRIME receiver attempts to decode the robust PRIME PDU header at block 1310. Because the robust PRIME header is more robust than the PRIME R1.3E header, it is more likely that the robust PRIME header can be correctly decoded and identified at block 1314. If the robust PRIME header is identified at block 1314, then the payload is decoded at block 1315. Otherwise, the process returns to block 1301 to search for the next PDU.

In sum, if the PRIME 1.3E header CRC fails and the robust header CRC also fails, a robust receiver may determine that an invalid preamble has been detected. If the PRIME 1.3E header CRC fails but the robust header CRC succeeds, the robust receiver may determine that a robust packet has been detected, and it may decode the PDU according to the header contents. If the PRIME 1.3E header CRC succeeds but the robust header CRC fails, the robust receiver may determine that a PRIME 1.3E packet has been detected, and it may decode the PDU according to the header contents. Finally, if both the PRIME 1.3E header CRC and the robust header CRC succeed (i.e., a longer, more reliable CRC), the robust receiver may determine that a robust packet has been detected and it may decode the PDU according to the header contents.

Although the example described in FIG. 13 refers to the specific case where two versions of a single standard (e.g., PRIME 1.3E and a more robust version of that standard) are used, in other embodiments these techniques may be extended to environments using more two or more versions of the same standard. Furthermore, it should be recognized that standards other than the PRIME standard may also be used.

Generally speaking, legacy devices that are configured only operate according to an earlier version of a standard (i.e., PRIME 1.3E, in this example) are not configured to receive the PDUs using a robust version of that standard. However, legacy devices can still detect the preamble (e.g., 701 in FIG. 7). In some implementations, the legacy device may detect a fail CRC when it attempts to decode a robust header, in which case it may execute a Carrier Sense Multiple Access (CSMA) procedure, backoff from the network for a predetermined amount of time, and operate during a Contention Free Period (CFP) of the MAC frame. Alternatively, in cases where the PDU shown in FIG. 12 is used, a legacy device may be able to decode first header portion 1202. Moreover, first header portion 1202 may include information regarding the packet's size or length, which in turn may enable the legacy device to perform a virtual carrier sense operation and backoff for a reduced amount of time (sufficient to avoid a collision, but less than a minimum time otherwise prescribed by the PLC network).

With respect to backward compatibility on a network level, in some cases, all devices in a network may follow the same protocol, and the PLC network may automatically adjust itself to the appearance of new nodes. For example, a base node (e.g., data concentrator 114 in FIG. 1) may determine a protocol type (e.g., by the type of beacon used). Robust devices may first look for PRIME 1.4 beacon. If one is not found, they may look for a legacy (e.g., PRIME 1.3E) beacon, then switch to legacy mode if appropriate. Meanwhile, legacy device may look for a legacy (e.g., PRIME 1.3E) beacon. If one is not found, they may transmit a Promotion Needed PDU (PNPDU). In some cases, robust nodes may be mandated to receive such a PNPDU. Then, the base node may either start an independent legacy network using CFP, or switch the entire network to legacy mode.

Additionally or alternatively, the same PLC network may support both legacy (e.g., PRIME 1.3E) and robust nodes. In some cases, the network may assign different beacon slots for legacy and robust PLC devices. Beacon signals may be transmitted using the robust version of the standard protocol, and the beacon length may be increased by a factor of approximately 4 (due to the 4-bit repetition). Moreover, the MAC frame length may be left unchanged, in which case it may provide room for fewer packets; or the MAC frame length may be increased.

As noted above, in certain embodiments, systems and methods for building transmitting, and receiving robust header and payload structures may be implemented or executed by one or more computer systems. One such system is illustrated in FIG. 14. In various embodiments, system 1400 may be a server, a mainframe computer system, a workstation, a network computer, a desktop computer, a laptop, mobile device, or the like. In different embodiments, these various systems may be configured to communicate with each other in any suitable way, such as, for example, via a local area network or the like.

As illustrated, computer system 1400 includes one or more processors 1410 coupled to a system memory 1420 via an input/output (I/O) interface 1430. Computer system 160 further includes a network interface 1440 coupled to I/O interface 1430, and one or more input/output devices 1425, such as cursor control device 1460, keyboard 1470, display(s) 1480, and/or mobile device 1490. In various embodiments, computer system 1400 may be a single-processor system including one processor 1410, or a multi-processor system including two or more processors 1410 (e.g., two, four, eight, or another suitable number). Processors 1410 may be any processor capable of executing program instructions. For example, in various embodiments, processors 1410 may be general-purpose or embedded processors implementing any of a variety of instruction set architectures (ISAs), such as the ×814, POWERPC®, ARM®, SPARC®, or MIPS® ISAs, or any other suitable ISA. In multi-processor systems, each of processors 1410 may commonly, but not necessarily, implement the same ISA. Also, in some embodiments, at least one processor 1410 may be a graphics processing unit (GPU) or other dedicated graphics-rendering device.

System memory 1420 may be configured to store program instructions and/or data accessible by processor 1410. In various embodiments, system memory 1420 may be implemented using any suitable memory technology, such as static random access memory (SRAM), synchronous dynamic RAM (SDRAM), nonvolatile/Flash-type memory, or any other type of memory. As illustrated, program instructions and data implementing certain operations such as, for example, those described in the figures above, may be stored within system memory 1420 as program instructions 1425 and data storage 1435, respectively. In other embodiments, program instructions and/or data may be received, sent or stored upon different types of computer-accessible media or on similar media separate from system memory 1420 or computer system 1400. Generally speaking, a computer-accessible medium may include any tangible storage media or memory media such as magnetic or optical media—e.g., disk or CD/DVD-ROM coupled to computer system 1400 via I/O interface 1430. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via network interface 1440.

In one embodiment, I/O interface 1430 may be configured to coordinate I/O traffic between processor 1410, system memory 1420, and any peripheral devices in the device, including network interface 1440 or other peripheral interfaces, such as input/output devices 1450. In some embodiments, I/O interface 1430 may perform any necessary protocol, timing or other data transformations to convert data signals from one component (e.g., system memory 1420) into a format suitable for use by another component (e.g., processor 1410). In some embodiments, I/O interface 1430 may include support for devices attached through various types of peripheral buses, such as a variant of the Peripheral Component Interconnect (PCI) bus standard or the Universal Serial Bus (USB) standard, for example. In some embodiments, the function of I/O interface 1430 may be split into two or more separate components, such as a north bridge and a south bridge, for example. In addition, in some embodiments some or all of the functionality of I/O interface 1430, such as an interface to system memory 1420, may be incorporated directly into processor 1410.

Network interface 1440 may be configured to allow data to be exchanged between computer system 1400 and other devices attached to a network, such as other computer systems, or between nodes of computer system 1400. In various embodiments, network interface 1440 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1450 may, in some embodiments, include one or more display terminals, keyboards, keypads, touchpads, scanning devices, voice or optical recognition devices, mobile devices, or any other devices suitable for entering or retrieving data by one or more computer system 1400. Multiple input/output devices 1450 may be present in computer system 1400 or may be distributed on various nodes of computer system 1400. In some embodiments, similar input/output devices may be separate from computer system 1400 and may interact with one or more nodes of computer system 1400 through a wired or wireless connection, such as over network interface 1440.

As shown in FIG. 14, memory 1420 may include program instructions 1425, configured to implement certain embodiments described herein, and data storage 1435, comprising various data accessible by program instructions 1425. In an embodiment, program instructions 1425 may include software elements of embodiments illustrated in the above figures. For example, program instructions 1425 may be implemented in various embodiments using any desired programming language, scripting language, or combination of programming languages and/or scripting languages (e.g., C, C++, C#, JAVA®, JAVASCRIPT®, PERL®, etc.). Data storage 1435 may include data that may be used in these embodiments (e.g., recorded communications, profiles for different modes of operations, etc.). In other embodiments, other or different software elements and data may be included.

A person of ordinary skill in the art will appreciate that computer system 1400 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

It will be understood that various operations discussed herein may be executed simultaneously and/or sequentially. It will be further understood that each operation may be performed in any order and may be performed once or repetitiously. In various embodiments, the operations discussed herein may represent sets of software routines, logic functions, and/or data structures that are configured to perform specified operations. Although certain operations may be shown as distinct logical blocks, in some embodiments at least some of these operations may be combined into fewer blocks. Conversely, any given one of the blocks shown herein may be implemented such that its operations may be divided among two or more logical blocks. Moreover, although shown with a particular configuration, in other embodiments these various modules may be rearranged in other suitable ways.

Many of the operations described herein may be implemented in hardware, software, and/or firmware, and/or any combination thereof. When implemented in software, code segments perform the necessary tasks or operations. The program or code segments may be stored in a processor-readable, computer-readable, or machine-readable medium. The processor-readable, computer-readable, or machine-readable medium may include any device or medium that can store or transfer information. Examples of such a processor-readable medium include an electronic circuit, a semiconductor memory device, a flash memory, a ROM, an erasable ROM (EROM), a floppy diskette, a compact disk, an optical disk, a hard disk, a fiber optic medium, etc. Software code segments may be stored in any volatile or non-volatile storage device, such as a hard drive, flash memory, solid state memory, optical disk, CD, DVD, computer program product, or other memory device, that provides tangible computer-readable or machine-readable storage for a processor or a middleware container service. In other embodiments, the memory may be a virtualization of several physical storage devices, wherein the physical storage devices are of the same or different kinds. The code segments may be downloaded or transferred from storage to a processor or container via an internal bus, another computer network, such as the Internet or an intranet, or via other wired or wireless networks.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

1. A method comprising:
performing, by a power line communication (PLC) device,
receiving a packet data unit (PDU);
applying bit-level repetition to at least one portion of the PDU to create a robust PDU; and
transmitting the robust PDU over a power line.

2. The method of claim 1, wherein the PLC device includes a PLC modem.

3. The method of claim 2, wherein applying the bit-level repetition includes performing the bit-level repetition after a convolution encoding operation.

4. The method of claim 3, wherein applying the bit-level repetition includes performing the bit-level repetition prior to an interleaving operation.

5. The method of claim 4, wherein applying the bit-level repetition includes repeating each bit of the at least one portion of the PDU four times.

6. The method of claim 4, wherein applying the bit-level repetition includes repeating each bit of the at least one portion of the PDU twice.

7. The method of claim 4, wherein the at least one portion of the PDU includes a header and excludes a payload.

8. The method of claim 4, wherein the at least one portion of the PDU includes a header and a payload.

9. The method of claim 4, further comprising:
performing, by the PLC device,
block interleaving symbols corresponding to the at least one portion of the PDU after the bit-level repetition to create the robust PDU.

10. The method of claim 9, wherein block interleaving includes 4-symbol interleaving.

11. The method of claim 9, further comprising:
performing, by the PLC device,
inserting pilot tones in tone data corresponding to the at least one portion of the PDU after the block interleaving to create the robust PDU.

12. The method of claim 11, wherein inserting the pilot tones includes inserting pilot tones every 6^{th} tone in the data.

13. The method of claim 11, further comprising:
performing, by the PLC device,
modulating the each tone in the tone data with respect to a nearest pilot tone to create the robust PDU.

14. The method of claim 11, wherein the robust PDU includes a first header portion carrying information using a legacy version of a PLC protocol and a second header portion carrying information using a current version of the PLC protocol.

15. A power line communication (PLC) device comprising:
a processor; and
a memory coupled to the processor, the memory configured to store program instructions executable by the processor to cause the PLC device to:
receive a packet data unit (PDU);
apply bit-level repetition to at least one portion of the PDU to create a repeated portion;
block interleave two or more symbols corresponding to the repeated portion to create a block interleaved portion;
insert pilot tones in the block interleaved portion;
modulate each tone in the block interleaved portion with respect to a nearest one of the inserted pilot tones to create a robust PDU; and
transmit the robust PDU over a power line.

16. The PLC device of claim 15, wherein the processor includes a digital signal processor (DSP), an application specific integrated circuit (ASIC), a system-on-chip (SoC) circuit, a field-programmable gate array (FPGA), a microprocessor, or a microcontroller.

17. The PLC device of claim 15, wherein the bit-level repetition repeats each bit of the at least one portion of the PDU four times, wherein the block interleaving interleaves sets of four symbols of the repeated portion, and wherein the pilot tones are inserted as every 6^{th} tone in the block interleaved portion.

18. The PLC device of claim 15, wherein the robust PDU includes a first header portion carrying information encoded using a first version of a PLC protocol and a second header portion carrying information encoded using a second version of the PLC protocol.

19. A tangible electronic storage medium having program instructions stored thereon that, upon execution by a processor within a power line communication (PLC) modem, cause the PLC modem to:
receive a PDU over a power line;
decode a first header portion of the PDU, the first header portion carrying information using a first version of a PLC protocol;
determine, based at least in part upon the information, (a) that a subsequent portion of the PDU includes other information encoded using a second version of the PLC protocol, and (b) a size or length of the subsequent portion; and
wait an amount of time corresponding to the size or length of the subsequent portion prior to attempting to communicate over the power line.

20. The tangible electronic storage medium of claim 19, wherein at least a portion of the received PDU is encoded using at least one of: bit-level repetition, multi-symbol interleaving, or nearest-pilot tone modulation.
